(19) United States
(12) Patent Application Publication
(10) Pub. No.: US 2025/0238764 A1
(43) Pub. Date: Jul. 24, 2025

(54) SYSTEMS AND METHODS FOR FACILITATING DEVICE REPLACEMENT WITHIN A CONNECTED PROPERTY

(71) Applicant: STATE FARM MUTUAL AUTOMOBILE INSURANCE COMPANY, Bloomington, IL (US)

(72) Inventors: Jackie O. Jordan, II, Bloomington, IL (US); John Donovan, Bloomington, IL (US); David Turrentine, Bloomington, IL (US); Torri Wollenschlager, Bloomington, IL (US); Bryan R. Nussbaum, Bloomington, IL (US); Deanna Stockweather, Normal, IL (US); Jeffrey W. Stoiber, Bloomington, IL (US); Kerstin Markwardt, Phoenix, AZ (US); Gail L. Carlson, Bloomington, IL (US); Kyle C. Schiebel, Bloomington, IL (US); Troy Winslow, Bloomington, IL (US); Joseph P. Harr, Bloomington, IL (US); Ellakate Wagner, Bloomington, IL (US); Michael Harris, JR., Normal, IL (US); Jennylind Sun, Bloomington, IL (US)

(21) Appl. No.: 14/873,726

(22) Filed: Oct. 2, 2015

Related U.S. Application Data
(60) Provisional application No. 62/220,383, filed on Sep. 18, 2015.
(60) Provisional application No. 62/201,671, filed on Aug. 6, 2015.
(60) Provisional application No. 62/200,375, filed on Aug. 3, 2015.
(60) Provisional application No. 62/198,813, filed on Jul. 30, 2015.
(60) Provisional application No. 62/197,343, filed on Jul. 27, 2015.
(60) Provisional application No. 62/193,317, filed on Jul. 16, 2015.
(60) Provisional application No. 62/189,329, filed on Jul. 7, 2015.
(60) Provisional application No. 62/187,651, filed on Jul. 1, 2015.
(60) Provisional application No. 62/187,624, filed on Jul. 1, 2015.
(60) Provisional application No. 62/187,642, filed on Jul. 1, 2015.
(60) Provisional application No. 62/187,666, filed on Jul. 1, 2015.
(60) Provisional application No. 62/187,645, filed on Jul. 1, 2015.
(60) Provisional application No. 62/105,407, filed on Jan. 20, 2015.
(60) Provisional application No. 62/060,962, filed on Oct. 7, 2014.

(51) Int. Cl. G06Q 10/20; G06Q 30/0251; G06Q 30/0601; G06Q 50/16

(52) U.S. Cl. CPC G06Q 10/20; G06Q 30/0269; G06Q 30/0613; G06Q 50/163

(57) ABSTRACT

The present embodiments relate to assessing the need to replace a smart or other device within a home and facilitating device replacement. A smart home controller at the home may retrieve usage data associated with a device and compare the usage data to baseline usage data. Based upon the comparison, the controller may determine that the device needs replacement and, in response, may communicate information associated with a replacement device to a home owner. The home owner may assess whether to replace the device and, if so, may order a replacement device from (and/or schedule an installation of the replacement device with) an appropriate manufacturer or retailer. As a result, failing devices may be replaced prior to a failure that causes damage to the home, and/or home owners may be timely prompted to investigate or replace failing devices. Insurance discounts may be provided based upon with the risk prevention/mitigation functionality.

### CROSS-REFERENCE TO RELATED APPLICATIONS

This application claims benefit of the filing date of U.S. Provisional Patent Application Nos. 62/060,962 (filed Oct. 7, 2014, and entitled “SYSTEMS AND METHODS FOR MANAGING DEVICES WITHIN A CONNECTED PROPERTY AND INSURANCE POLICIES ASSOCIATED THEREWITH”); 62/105,407 (filed Jan. 20, 2015, and entitled “SYSTEMS AND METHODS FOR MANAGING DEVICES WITHIN A CONNECTED PROPERTY AND INSURANCE POLICIES ASSOCIATED THEREWITH”); 62/187,624 (filed Jul. 1, 2015, and entitled “SYSTEMS AND METHODS FOR FACILITATING DEVICE REPLACEMENT WITHIN A CONNECTED PROPERTY”); 62/187,645 (filed Jul. 1, 2015, and entitled “SYSTEMS AND METHODS FOR MANAGING BUILDING CODE COMPLIANCE FOR A PROPERTY”); 62/187,651 (filed Jul. 1, 2015, and entitled “SYSTEMS AND METHODS FOR AUTOMATICALLY GENERATING AN ESCAPE ROUTE”); 62/187,642 (filed Jul. 1, 2015, and entitled “SYSTEMS AND METHODS FOR ANALYZING SENSOR DATA TO DETECT PROPERTY INTRUSION EVENTS”); 62/187,666 (filed Jul. 1, 2015, and entitled “SYSTEMS AND METHODS FOR IMPROVED ASSISTED OR INDEPENDENT LIVING ENVIRONMENTS”); 62/189,329 (filed Jul. 7, 2015, and entitled “SYSTEMS AND METHODS FOR MANAGING WARRANTY INFORMATION ASSOCIATED WITH DEVICES POPULATED WITHIN A PROPERTY”); 62/193,317 (filed Jul. 16, 2015, and entitled “SYSTEMS AND METHODS FOR MANAGING SMART DEVICES BASED UPON ELECTRICAL USAGE DATA”); 62/197,343 (filed Jul. 27, 2015, and entitled “SYSTEMS AND METHODS FOR CONTROLLING SMART DEVICES BASED UPON IMAGE DATA FROM IMAGE SENSORS”); 62/198,813 (filed Jul. 30, 2015, and entitled “SYSTEMS AND METHODS FOR MANAGING SERVICE LOG INFORMATION”); 62/200,375 (filed Aug. 3, 2015, and entitled “SYSTEMS AND METHODS FOR AUTOMATICALLY RESPONDING TO A FIRE”); 62/201,671 (filed Aug. 6, 2015, and entitled “SYSTEMS AND METHODS FOR AUTOMATICALLY MITIGATING RISK OF DAMAGE FROM BROKEN CIRCUITS”); 62/220,383 (filed Sep. 18, 2015, and entitled “METHODS AND SYSTEMS FOR RESPONDING TO A BROKEN CIRCUIT”)—which are all hereby incorporated by reference in their entireties.

### FIELD OF THE DISCLOSURE

The present disclosure generally relates to managing a connected property. More particularly, the present disclosure relates to facilitating various operations and functionalities associated with monitoring device usage and facilitating device replacement according to the device usage.

### BACKGROUND

With the proliferation of the “internet of things,” more household devices and items are gaining communication and network connectivity capabilities. The new capabilities are enabling easier data detection and more accurate information and metrics. However, the channels to control and maintain devices and items as a response to certain conditions are limited. Additionally, current insurance policy processing systems associated with homeowner and personal property insurance may not account for the connected devices and/or generally improve more accurate information.

### BRIEF SUMMARY

The present embodiments may, inter alia, manage operation of connected devices and items in response to certain conditions and commands. Further, the present embodiments may effectively and efficiently communicate relevant information associated with connected devices and items. Additionally, the present embodiments may facilitate insurance processing associated with the connected devices and items based upon data received from the connected devices and items, among other functionalities. One particular functionality relates to monitoring usage of the connected devices and facilitating replacement of the connected devices based upon the usage data.

Generally, the present embodiments may relate to (1) home control and/or automation, as well as (2) loss prevention, reduction, and/or mitigation through proactively determining when devices may need to be replaced, notifying an individual of device replacement, and/or facilitating purchases of replacement devices with the individual. The foregoing functionality may also be used by an insurance provider to generate, update, or adjust insurance policies, premiums, rates, discounts, points, and/or rewards, and/or make recommendations to an insured individual.

According to one embodiment, a computer-implemented method of monitoring device usage within a property may be provided. The property may be populated with a hardware controller in communication with a plurality of devices. The computer-implemented method may include (1) retrieving, by the hardware controller, device usage data from a device disposed within the property; (2) identifying, from the device usage data, an actual usage amount of the device; and/or (3) accessing a baseline usage amount associated with the device. The computer-implemented method may further include (4) comparing, by one or more processors, the actual usage amount to the baseline usage amount to determine that the device needs replacement; (5) receiving, from a third-party entity associated with the device, information associated with a replacement device for the device; and/or (6) communicating the information to an electronic device of an individual associated with the property to facilitate device replacement prior to device failure causing damage to the property, and/or otherwise prompting the individual to timely replace a failing or faulty device. The method may include additional, less, or alternate actions, including those discussed elsewhere herein.

According to another embodiment, a computer-implemented method of monitoring device usage within a property may be provided. The property may be populated with a hardware controller in communication with a plurality of devices. The computer-implemented method may include (1) retrieving, by a server from the hardware controller, device usage data associated with a device disposed within the property; (2) identifying, from the device usage data, an actual usage amount of the device; and/or (3) accessing a baseline usage amount associated with the device. The computer-implemented method may further include (4) comparing, by one or more processors of the server, the actual usage amount to the baseline usage amount to determine that the device needs replacement; (5) receiving, from a third-party entity associated with the device, information associated with a replacement device for the device; and/or (6) communicating the information to an electronic device of an individual associated with the property to facilitate or prompt failing or faulty device replacement, such as by a homeowner, and/or preventing damage to the property resulting from device failure. The method may include additional, less, or alternate functionality, including that discussed elsewhere herein.

According to a further embodiment, a hardware controller for monitoring device usage within a property may be provided. The hardware controller may be in communication with a plurality of devices. The hardware controller may include a communication module adapted to retrieve device usage data from a device disposed within the property, a memory adapted to store non-transitory computer executable instructions, and/or a processor adapted to interface with the communication module. The processor may be configured to execute the non-transitory computer executable instructions to cause the processor to identify, from the device usage data, an actual usage amount of the device; access a baseline usage amount associated with the device; and/or compare the actual usage amount to the baseline usage amount to determine that the device needs replacement. The processor may be further configured to receive, via the communication module from a third-party entity associated with the device, information associated with a replacement device for the device; and/or transmit, via the communication module, the information to an electronic device of an individual associated with the property to facilitate or prompt device replacement, such as by the homeowner, and/or preventing damage to the property resulting from device failure.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed herein. It should be understood that each Figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary environment including components and entities associated with managing device operation and facilitating insurance policy processing, in accordance with some embodiments.

FIG. 2 is an exemplary signal diagram associated with monitoring device usage within a property, in accordance with some embodiments.

FIG. 3 is a flow diagram of an exemplary computer-implemented method of monitoring device usage within a property, in accordance with some embodiments.

FIG. 4 is a block diagram of an exemplary controller in accordance with some embodiments.

FIG. 5 is a block diagram of an exemplary processing server in accordance with some embodiments.

FIGS. 6A and 6B depict exemplary interfaces associated with facilitating device replacement, in accordance with some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, managing operation of devices or personal property within a home or other type of property, such as household furniture, appliances, electronics, vehicles (e.g., cars, boats, motorcycles), and/or other personal belongings (e.g., clothing, jewelry, antiques). Generally, a home or property may have a “smart” central controller that may be wirelessly connected, or connected via hard-wire, with various household related items, devices, and/or sensors. The central controller may be associated with any type of property, such as homes, office buildings, restaurants, farms, and/or other types of properties.

The central controller, and/or one or more remote processors or servers associated with an insurance provider, may be in wireless or wired communication with various “smart” items or devices, such as smart appliances (e.g., clothes washer, dryer, dish washer, refrigerator, etc.); smart heating devices (e.g., furnace, space heater, etc.); smart cooling devices (e.g., air conditioning units, fans, ceiling fans, etc.); smart plumbing fixtures (e.g., toilets, showers, water heaters, piping, interior and yard sprinklers, etc.); smart cooking devices (e.g., stoves, ovens, grills, microwaves, etc.); smart wiring, lighting, and lamps; smart personal vehicles; smart thermostats; smart windows, doors, or garage doors; smart window blinds or shutters; and/or other smart devices and/or sensors capable of wireless or wired communication. Each smart device (or sensor associated therewith), as well as the central controller and/or insurance provider remote processor(s), may be equipped with a processor, memory unit, software applications, wireless transceivers, local power supply, various types of sensors, and/or other components.

The central controller, and/or insurance provider remote processor(s), may collect or retrieve various data from the devices or personal property, analyze the data, and/or identify various actions to facilitate based upon the analysis. In particular, the central controller and/or insurance provider remote processor(s) may retrieve usage data from the smart devices, where the usage data indicates an amount of usage associated with the smart devices. The central controller and/or insurance provider remote processor(s) may compare the usage data to baseline usage data for the corresponding smart device, where the baseline usage data may correspond to a recommended usage amount, an operation limit, a minimum effective amount, and/or other metrics.

Based upon the comparison, the central controller and/or insurance provider remote processor(s) may determine that a replacement device is needed for the smart device. The central controller and/or insurance provider remote processor(s) may communicate with a third-party entity, as well as a user or mobile device of an individual associated with the property (e.g., an occupant or owner of the property). The third-party entity may be a manufacturer, supplier, servicer, or retailer of the replacement device and/or one or more of the smart devices. The individual may use the user device to access information associated with the replacement device and/or to purchase (and/or install) a replacement device.

The systems and methods discussed herein address a challenge that is particular to property management. In particular, the challenge relates to a difficulty in assessing or determining the need for replacing connected devices within a property, as well as a difficulty in facilitating a replacement of a connected device. This is particularly apparent when certain devices are difficult to access or are otherwise neglected. In conventional circumstances, devices may fail or experience fault conditions without warning, which necessitates property owners to repair or replace the devices. In contrast, the systems and methods monitor connected device operation and analyze usage data to dynamically assess the need to replace the connected device. Therefore, because the systems and methods employ the collection and analysis of operation data associated with connected devices within a property, the systems and methods are necessarily rooted in computer technology in order to overcome the noted shortcomings that specifically arise in the realm of property management.

Similarly, the systems and methods provide improvements in a technical field, namely, home automation. Instead of the systems and methods merely being performed by hardware components using basic functions, the systems and methods employ complex steps that go beyond the mere concept of simply retrieving and combining data using a computer. In particular, the hardware components detect connected devices, receive device usage data from the connected devices, analyze the device usage data in combination with additional data to assess the need to replace the connected devices, and/or facilitate the option to purchase replacement devices. Additionally, because a central controller in a property retrieves and analyzes device usage data from a plurality of connected devices in the property, the central controller and the connected devices are part of a “thin client” environment that improves data persistence and information processing. This combination of elements further impose meaningful limits in that the operations are applied to improve home automation by detecting when connected devices may need to be replaced, and facilitating a replacement of the devices in a meaningful and effective way.

According to implementations, the systems and methods may support a dynamic, real-time or near-real-time analysis of any received data. In particular, the central controller and/or insurance provider may retrieve and/or receive real-time usage data from the devices, analyze the usage data in real time, and dynamically determine an action or command to take based upon the analysis. Additionally, the central controller and/or insurance provider may receive and analyze device replacement information in real-time, assess the need for a replacement device in real-time, and dynamically facilitate the device replacement in real-time or near-real-time. Accordingly, the real-time capability of the systems and methods enable the smart devices to be efficiently and effectively replaced when the usage data indicates a need for replacement.

Generally, the systems and methods offer numerous benefits to operation of devices within the property, as well as to individuals associated with the property. In particular, the systems and methods may automatically detect potential or actual issues with the property that the individuals may not realize exist, and may automatically facilitate preventative or corrective actions to address the issues. As a result, security associated with the property may improve. Further, the systems and methods improve loss prevention and mitigate actual loss. Additionally, the systems and methods may improve energy consumption. As a further benefit, individuals associated with the property may be able to preemptively purchase replacement devices for smart devices that may be nearing failure or other defect issues.

The systems and methods may further offer a benefit to insurance providers and customers thereof. Particularly, the present embodiments may facilitate (a) providing and updating insurance policies; (b) the handling or adjusting of home insurance claims; (c) the disbursement of monies related to insurance claims; (d) modifying insurance coverage amounts; (e) updating and improving damage estimate models; and/or (f) other insurance-related activities.

The systems and methods may further offer a benefit to customers by offering improved insurance claim processing. Further, the insurance providers may stand out as a cost-effective insurance provider, thereby retaining existing customers and attracting new customers. It should be appreciated that further benefits to the systems and methods are envisioned.

The method may also include adjusting an insurance policy, premium, or discount (such as a homeowners, renters, auto, home, health, or life insurance policy, premium, or discount) based upon the functionality discussed herein, and/or an insured having a home and/or mobile device with such functionality.

### I. EXEMPLARY ENVIRONMENT AND COMPONENTS FOR ASSESSING DEVICE OPERATION AND FUNCTIONALITIES RELATING THERETO

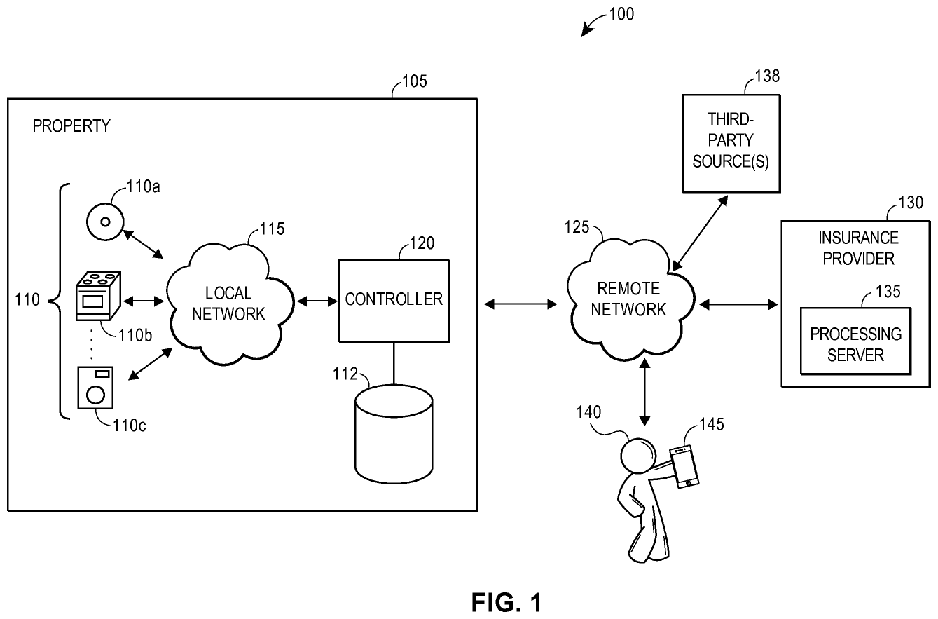

FIG. 1 depicts an exemplary environment 100 including components and entities for managing devices associated with a property and processing insurance policies associated therewith. Although FIG. 1 depicts certain entities, components, and devices, it should be appreciated that additional, fewer, or alternate entities and components are envisioned.

As illustrated in FIG. 1, the environment 100 may include a property 105 that contains a controller 120 and a plurality of devices 110 (or smart devices) that may be each connected to a local communication network 115. Each of the plurality of devices 110 may be a “smart” device that may be configured with one or more sensors capable of sensing and communicating operating data associated with the corresponding device 110. As shown in FIG. 1, the plurality of devices 110 may include a smart alarm system 110a, a smart stove 110b, and/or a smart washing machine 110c. Each of the plurality of devices 110 may be located within or proximate to the property 105 (generally, “on premises”). Although FIG. 1 depicts only one property 105, it should be appreciated that multiple properties are envisioned, each with its own controller and devices. Further, it should be appreciated that additional, fewer, or alternate devices may be present in the property 105.

In some cases, the plurality of devices 110 may be purchased from a manufacturer with the “smart” functionally incorporated therein. In other cases, the plurality of devices 110 may have been purchased as “dumb” devices and subsequently modified to add the “smart” functionality to the device. For instance, a homeowner may purchase an alarm system that installs sensors on or near a door to detect when a door has been opened and/or unlocked.

In some embodiments, the plurality of devices 110 may monitor their own status or condition via the sensors to detect any issues or problems. In response to detecting issues or problems, the plurality of devices 110 may be able to indicate the issues or problems via display components, such as LED lights, display screens, or other visual indicators. In further embodiments, the controller 120 may be configured to monitor, via sensor data, whether the plurality of devices 110 and/or parts thereof have been installed correctly, whether replacement parts are new and/or otherwise in good condition, and/or other conditions associated with the plurality of devices 110 and/or parts thereof.

The plurality of devices 110 may be configured to communicate with a controller 120 via the local communication network 115. The local communication network 115 may facilitate any type of data communication between devices and controllers located on or proximate to the property 105 via any standard or technology (e.g., LAN, WLAN, any IEEE 802 standard including Ethernet, and/or others). The local communication network 115 may further support various short-range communication protocols, such as Bluetooth®, Bluetooth® Low Energy, near field communication (NFC), radio-frequency identification (RFID), and/or other types of short-range protocols.

According to aspects, the plurality of devices 110 may transmit, to the controller 120 via the local communication network 115 (and/or to the insurance provider 130 remote processing server 135 via the network 125), operational data gathered from sensors associated with the plurality of devices 110. The operational data may be audio data, image or video data, status data, usage amounts, and/or other data or information. For instance, the operational data may indicate that a window has been shattered; the presence of a person, fire, or water in a room; the sound made near a smart device; and/or other information pertinent to an operation state or status of the plurality of devices 110. For further instance, the operational data may include motion data that may indicate whether any individuals are within the property 105 (i.e., whether the property 105 is occupied or unoccupied). Additionally, the operational data may include device usage data. The operational data may include a timestamp representing the time that the operational data was recorded.

In some cases, the plurality of devices 110 may transmit, to the controller 120 (and/or insurance provider 130 remote processing server 135), various data and information associated with the plurality of devices 110. In particular, the data and information may include location data within the property, as well as various costs and prices associated with the plurality of devices 110. For instance, a washing machine may include a component such as a data tag that stores a location of the washing machine within the property 105, a retail price of the washing machine, and/or replacement costs of various parts of (or the entirety of) the washing machine. The various data and information may be programmable and updatable by an individual or automatically by the controller 120.

The controller 120 may be coupled to a database 112 that stores various operational data and information associated with the plurality of devices 110. Although FIG. 1 depicts the database 112 as coupled to the controller 120, it is envisioned that the database 112 may be maintained in the “cloud” such that any element of the environment 100 capable of communicating over either the local network 115 or one or more other networks 125 may directly interact with the database 112.

In some embodiments, the database 112 may organize the operational data according to which individual device 110 the data may be associated and/or the room or subsection of the property in which the data was recorded. Further, the database 112 may maintain an inventory list that includes the plurality of devices 110, as well as various data and information associated with the plurality of devices 110 (e.g., locations, replacement costs, etc.).

In one embodiment, the database 112 may maintain various operation states of the plurality of devices 110. In particular, the operation states may specify various settings of the plurality of devices 110 such that when the respective device is configured at the setting(s), the respective device will operate in the corresponding operation state. For instance, an operation state for a smart thermostat may be “heat conservation” whereby the corresponding setting is 64 degrees (as opposed to a more “normal” 70 degree setting). It should be appreciated that each operation state may specify settings for more than one of the devices 110.

The controller 120 (and/or the plurality of devices 112) may be configured to communicate with other components and entities, such as an insurance provider 130 and various third party source(s) 138 via the network(s) 125. According to some embodiments, the network(s) 125 may facilitate any data communication between the controller 120 located on the property 105 and entities or individuals remote to the property 105 via any standard or technology (e.g., GSM, CDMA, TDMA, WCDMA, LTE, EDGE, OFDM, GPRS, EV-DO, UWB, IEEE 802 including Ethernet, WiMAX, Wi-Fi, and/or others). In some cases, both the local network 115 and the network 125(s) may utilize the same technology.

Generally, the insurance provider 130 may be any individual, group of individuals, company, corporation, or other type of entity that may issue insurance policies for customers, such as a home insurance policy associated with the property 105. According to the present embodiments, the insurance provider 130 may include one or more processing server(s) 135 configured to facilitate the functionalities as discussed herein. Although FIG. 1 depicts the processing server 135 as a part of the insurance provider 130, it should be appreciated that the processing server 135 may be separate from (and connected to or accessible by) the insurance provider 130.

Further, although the present disclosure describes the systems and methods as being facilitated in part by the insurance provider 130, it should be appreciated that other non-insurance related entities may implement the systems and methods. For instance, a general contractor may aggregate the insurance-risk data across many properties to determine which appliances or products provide the best protection against specific causes of loss, and/or deploy the appliances or products based upon where causes of loss are most likely to occur. Accordingly, it may not be necessary for the property 105 to have an associated insurance policy for the property owners to enjoy the benefits of the systems and methods.

The third-party source(s) 138 may represent any entity or component that is configured to obtain, detect, and/or determine data or information that may be relevant to the devices 110 of the property 105. In some embodiments, the third-party source(s) 138 may be a manufacturer, supplier, servicer, or retailer of the any of the devices 110, as well as for replacement devices for the devices 110. For instance, if one of the devices 110 is a refrigerator, the third-party source 138 may be refrigerator manufacturer that sells refrigerators of the same or different types or models as the refrigerator device 110. The third-party source(s) 138 may store data associated with a replacement device (e.g., cost, retail location, general information, availability, or the like). The third-party source(s) 138 may be configured to communicate various data or information to the controller 120 and/or to the insurance provider 130 via the network(s) 125, whereby the controller 120 and/or the insurance provider 130 may examine the data or information to facilitate various functionalities.

The controller 120, the insurance provider 130, and/or the processing server 135, and the third-party source(s) 138 may also be in communication, via the network(s) 125, with an electronic device 145 associated with an individual 140. In some embodiments, the individual 140 may have an insurance policy (e.g., a home insurance policy) for the property 105 or a portion of the property 105, or may otherwise be associated with the property 105 (e.g., the individual 140 may live in the property 105). The electronic device 145 may be a mobile device, such as a smartphone, a desktop computer, a laptop, a tablet, a phablet, a smart watch, smart glasses, wearable electronics, pager, personal digital assistant, or any other electronic device, including computing devices configured for wireless radio frequency (RF) communication and data transmission. In some implementations, the controller 120 (and/or insurance provider 130 remote processing server 135) may communicate, to the individual 140 via the electronic device 145, an indication of the operation of the plurality of devices 110, such as the commands transmitted to the plurality of devices 110. Further, the controller 120 (and/or insurance provider 130 remote processing server 135) may enable the individual 140 to remotely control various of the plurality of devices 110 via the electronic device 145.

According to some other implementations, the controller 120 (and/or insurance provider 130 remote processing server 135) may detect damage to any of the plurality of devices 110 and/or to other portions of the property 105. The controller 120 (and/or insurance provider 130 remote processing server 135) may generate notifications or alerts associated with the detected damage, and/or communicate the notifications or alerts to the electronic device 145 via the network 125. Further, the controller 120 (and/or insurance provider 130 remote processing server 135) may also generate a proposed insurance claim that indicates the damage and transmit, via the network 125, the proposed insurance claim related to the electronic device 145. The proposed insurance claim may contain pre-populated fields that indicate various information and data, such as causes of loss (e.g., water, wind, fire, etc.); damaged devices; costs associated with the damaged devices; time, date, and/or location of the insurance-related event; and/or other information included in an insurance claim.

The controller 120 (and/or insurance provider 130 remote processing server 135) may also transmit any modifications to insurance policies based upon detected data from the plurality of devices 110. In response, the homeowner 140 may accept the proposed insurance claim or make modifications to the proposed insurance claim, and/or otherwise accept/reject any modifications to the insurance policy. The electronic device may transmit, via the network 125, the accepted or modified insurance claim back to the controller 120 (and/or insurance provider 130 remote processing server 135).

The controller 120 may facilitate any processing of the insurance claim with the processing server 135 of the insurance provider 130. Additionally or alternatively, the processing server 135 may facilitate the proposed insurance claim communications and processing directly with the customer 140. In some implementations, the insurance provider 130 remote processing server 135 may provide the same functionality as that described herein with respect to the controller 120.

The controller 120, and/or the insurance provider 130 remote processing server 135, may also assess usage of various of the devices 110, and/or may notify individuals of potential concerns, lack of usage, and/or other information. In particular, the controller 120, and/or the insurance provider 130 remote processing server 135, may gather various data from the devices 110, and determine that there may be an issue or concern with one or more of the devices 110. The issue or concern may have a risk of, in some circumstances, leading to a loss or damage to the property 105, or breakdown or malfunctioning of the corresponding device 110. For instance, usage data associated with a water heater may indicate that the water heater is nearing its recommended lifetime usage amount. For further instance, the usage data may include electrical load data associated with electricity consumption by a piece of equipment, where the electrical load data may indicate that the piece of equipment is nearing an end of its useful life or should be replaced. As an additional example, the usage data may include audio data associated with a running or operating piece of equipment (e.g., sound of a pump, motor, dish washer, clothes washer or dryer, air conditioning unit, refrigerator, furnace, sump pump or sump pump motor, etc.). The audio data may indicate that the piece of equipment is nearing an end of its useful life or should be replaced.

The insurance provider 130 remote processing server 135, may generate a corresponding alert or notification, and send the alert or notification to the individual, such as via wireless communication to their mobile device. For further instance, the controller 120, and/or the insurance provider 130 remote processing server 135, may detect that a circuit breaker or a ground fault circuit interrupter (GFCI) is tripped, and/or generate a corresponding notification. Further, for instance, the controller 120, and/or the insurance provider 130 remote processing server 135, may monitor the ages of the devices 110 to determine when one of the devices 110 may need to be replaced.

### II. EXEMPLARY COMMUNICATION FLOW FOR ASSESSING DEVICE USAGE DATA AND FACILITATING REPLACEMENT DEVICE PURCHASING

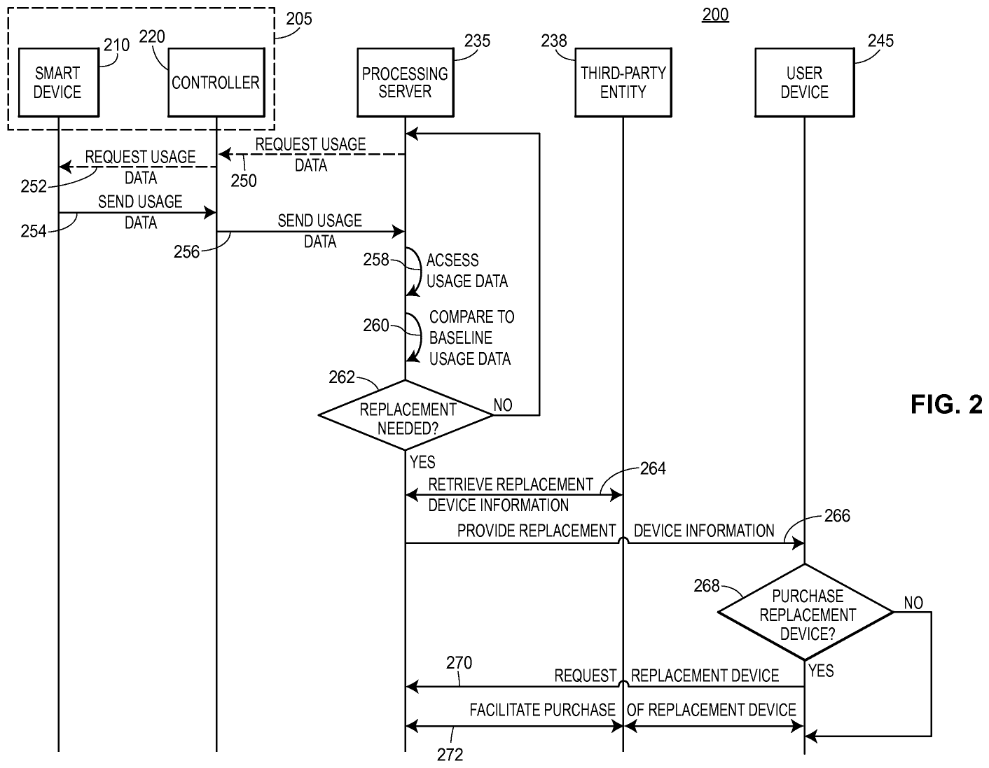

Referring to FIG. 2, illustrated is an exemplary signal diagram 200 associated with collecting smart device usage data and facilitating various functionalities relating thereto. FIG. 2 may include a smart device 210 (such as one of the smart devices 110 (or one of the plurality of devices) as discussed with respect to FIG. 1), a controller 220 (such as the controller 120 as discussed with respect to FIG. 1), a processing server 235 (such as the processing server 135 as discussed with respect to FIG. 1), a third-party entity 238 (such as the third-party entity 138 as discussed with respect to FIG. 1), and/or a user device 245 (such as the user device 145 as discussed with respect to FIG. 1).

The smart device 210 and the controller 220 may be located within a property 205 (such as the property 105 as discussed with respect to FIG. 1). According to some embodiments, the user device 245 may belong to an individual associated with the property 205, such as a resident of the property 205 and/or an individual having an insurance policy for the property 205. The third-party entity 238 may be any entity, such as manufacturer, retailer, and/or servicer, that may facilitate the replacement of smart devices.

The signal diagram 200 may begin when the processing server 235 optionally requests (250) the controller 220 for usage data associated with the smart device 210. The controller 220 may relay (252) the request for usage data to the smart device 210 via a network connection within the property 205. The request may specify various parameters, such as usage data for a specific part or portion of the smart device 210, as well as usage data for a particular time period (e.g., month-by-month user data, year-to-date usage data) or usage data for the lifetime of the smart device 210. The smart device 210 may send (254) its usage data to the controller 220 via the network connection. It should be appreciated that the smart device 210 may send its usage data automatically as a result of certain triggers (e.g., a usage amount threshold or at a set time), or in response to the request from the processing serve 235.

After receiving the usage data from the smart device 210, the controller 220 may send (256) the usage data to the processing server 235, at which point the processing server 235 may assess (258) or examine the usage data. In particular, the processing server 235 may identify an actual usage amount of the smart device 210. The actual usage amount may correspond to an operating time of the smart device 210, and may account for usage of the smart device 210 across various time periods. For example, if the smart device 210 is a refrigerator, the usage data may indicate that the refrigerator has been in use for nine (9) years and eleven (11) months.

The processing server 235 may compare (260) the usage data (and the actual usage amount) to a set of baseline usage data. In some scenarios, the baseline usage data may correspond to a recommended amount of usage for the smart device 210. In other scenarios, the baseline usage data may correspond to a usage amount or time period outlined in a warranty (e.g., a 10-year warranty). In some implementations, the processing server 235 may retrieve the baseline usage data from another entity, such as the third-party entity 238. The baseline usage data may correspond to other metrics or parameters associated with the smart device 210 such as, for example, an operation limit, a minimum effective amount, and/or other parameters.

Based upon the comparison in (260), the processing server 235 may determine (262) if a replacement device is needed. For example, a replacement device may be needed if the actual usage amount exceeds a usage amount indicated the baseline usage data. For further example, a replacement device may be needed if the actual usage amount is within a certain amount or percentage (e.g., 5%) of the usage amount indicated in the baseline usage data. It should be appreciated that other conditions for needing a replacement device are envisioned.

If the processing server 235 determines that a replacement device is not needed (“NO”), processing may return to 250 in which the processing server 235 may request usage data from another smart device. If the processing server 235 determines that a replacement device is needed (“YES”), then the processing server 235 may retrieve (264) replacement device information from the third-party entity 238. In particular, the replacement device information may include information associated with replacing the smart device 210 including, for example, an indication of a replacement device, images of the replacement device, cost information, delivery/pickup information, and/or other information.

The processing server 235 may provide (266) the replacement device information to the user device 245 for review by the individual. In particular, the individual may view the replacement device information, as well as any usage information associated with the smart device 210, and assess (268) whether to purchase a replacement device for the smart device 210. If the individual decides to not purchase the replacement device (“NO”), processing may end or proceed to any other functionality. If the individual decides to purchase the replacement device (“YES”), the individual may use the user device 245 to request (270) a purchase of the replacement device. According to embodiments, the user device 245 may send the request to the processing server 235 (as depicted in FIG. 2) or to the third-party entity 238.

The processing server 235, the third-party entity 238, and/or the user device 245 may facilitate (272) a purchase of the replacement device. In one implementation, the user device 235 may submit an order for the replacement device with the third-party entity 238 via an e-commerce platform. The order for the replacement device may have an associated delivery or pickup date. It should be appreciated that additional implementations for facilitating the purchase (and/or installation) of the replacement device are envisioned.

Although FIG. 2 depicts the processing server 235 performing various steps and determinations, it should be appreciated that the controller 220 may perform the same or similar steps or determinations. For example, the controller 220 may request the usage data, access the baseline usage data, determine the need for a replacement device, communicate associated information to the user device 245, and/or facilitate the purchase of the replacement device.

### III. EXEMPLARY METHOD FOR ASSESSING DEVICE USAGE DATA AND FACILITATING REPLACEMENT DEVICE PURCHASING

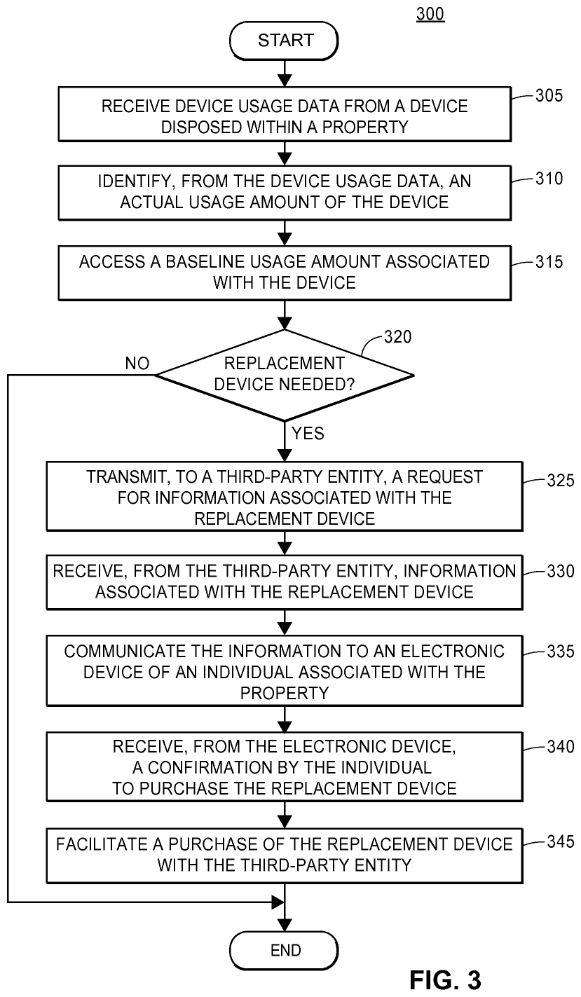

Referring to FIG. 3, depicted is a block diagram of an exemplary method 300 of monitoring device usage within a property. The method 300 may be facilitated by an electronic device within the property, such as the controller 120, that may be in direct or indirect communication with an insurance provider (such as the insurance provider 130 or a remote processor or server thereof), or a third-party entity such as a manufacturer, supplier, servicer, or retailer of one or more of the devices 110. In some implementations, the method 300 may be facilitated by an insurance provider (such as the insurance provider 130).

The controller 120, and/or the insurance provider 130 remote processing server 135, may also monitor usages of the devices 110. The controller 120, and/or the insurance provider 130 remote processing server 135 may detect when one of the devices 100 has an increased usage such as a usage spike, and may notify any pertinent individuals of the increased usage.

The method 300 may begin when the controller retrieves (block 305) device usage data from a device disposed within a property, such as one of the devices 110. In some embodiments, the device usage data may include operation data for the corresponding device, and may include operation data over a specific time period, such as daily usage data, monthly usage data, and/or the like. The controller may store the device usage data for later retrieval or analysis. The controller may identify (block 310), from the device usage data, an actual usage amount of the device. In some implementations, the actual usage amount may correspond to an operating time of the device (i.e., how long a device is operational), and may specify a corresponding time period (e.g., monthly, yearly, lifetime, etc.).

The controller may access (block 315) a baseline usage amount associated with the device. In some implementations, the controller may retrieve the baseline usage amount from a third-party entity, such as a manufacturer, supplier, servicer, or retailer of the device. In other implementations, the controller may access the baseline usage amount from local storage. The baseline usage amount may specify a certain threshold usage of the device for a certain time period (e.g., monthly, yearly, lifetime, etc.). For example, the recommended lifespan of a water heater may be ten (10) years. The baseline usage amount may also correspond to a recommended usage amount (such as that specified by a manufacturer of the device), an operation limit for the device, or a minimum effective amount for the device.

The controller may determine (block 320) if a replacement device is needed, based upon the actual usage amount and the baseline usage amount. In some implementations, the controller may determine that a replacement device is needed if the actual usage amount exceeds the baseline usage amount. In other implementations, the controller may determine that a replacement device is needed if the actual usage amount is within a certain percentage or amount of the baseline usage amount. If the controller determines that a replacement device is not needed (“NO”), processing may end or proceed to other functionality.

In contrast, if the controller determines that a replacement device is needed (“YES”), the controller may transmit (block 325), to a third-party entity, a request for information associated with the replacement device. For example, the third-party entity may be a manufacturer, supplier, servicer, or retailer of the device. The controller may receive (block 1030), from the third-party entity, information associated with the replacement device. For example, the information may include an offer for sale, a discount on the replacement device, general information on the replacement device, a location where the device is for sale, and/or other information. The information may, in some cases, include a link that an individual may access to purchase the replacement device, and/or arrange a time for installation of the replacement device.

The controller may communicate (block 335) the information to an electronic device of an individual associated with the property. The controller may store an identification of the electronic device. For example, the electronic device may be a smartphone belonging to an owner and/or occupant of the property. The controller may receive (block 340), from the electronic device, a confirmation by the individual to purchase the replacement device. In some implementations in which the information includes a link to purchase the replacement device, the electronic device may enable the individual to select the link to facilitate an e-commerce purchase (and/or ultimate installation) of the replacement device, and the electronic device may relay an order to purchase (and/or install) the replacement device to the controller. The controller may facilitate (block 345) a purchase (and/or installation) of the replacement device with the third-party entity. In some scenarios, the electronic device may directly facilitate the purchase (and/or installation) of the replacement device.

### IV. EXEMPLARY CONTROLLER

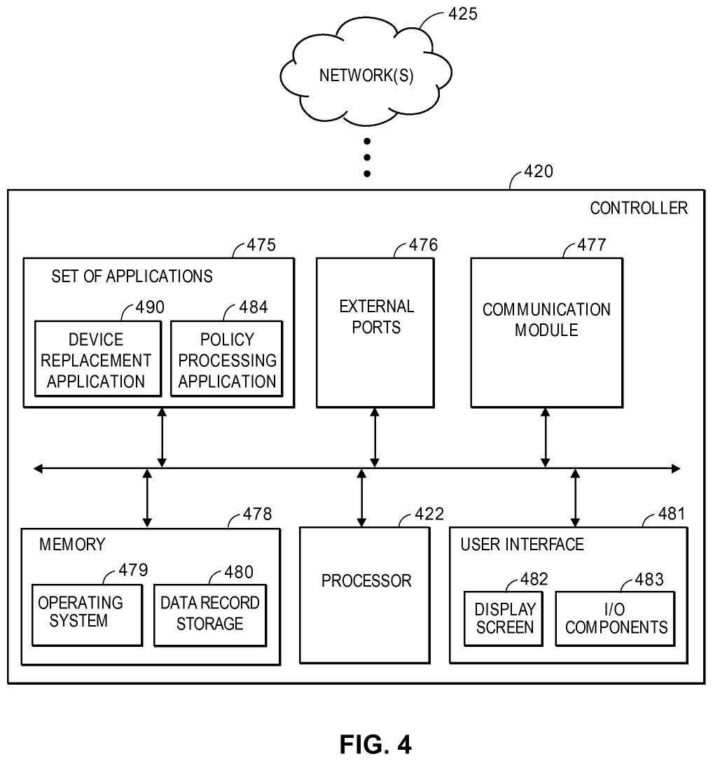

FIG. 4 illustrates a diagram of an exemplary controller 420 (such as the controller 120 discussed with respect to FIG. 1) in which the functionalities as discussed herein may be implemented. It should be appreciated that the controller 420 may be associated with a property, as discussed herein.

The controller 420 may include a processor 422, as well as a memory 478. The memory 478 may store an operating system 479 capable of facilitating the functionalities as discussed herein, as well as a set of applications 475 (i.e., machine readable instructions). For instance, one of the set of applications 475 may be a policy processing application 484 configured to access and process customer insurance policies, and another of the set of applications 475 may be a device replacement application 490 configured to facilitate an order for a replacement device. It should be appreciated that other applications are envisioned.

The processor 422 may interface with the memory 478 to execute the operating system 479 and the set of applications 475. According to some embodiments, the memory 478 may also include a data record storage 480 that stores various data and information associated with devices and insurance policies. The policy processing application 484 and the device replacement application 490 may interface with the data record storage 480 to retrieve relevant information that the policy processing application 484 and the device replacement application 490 may use to manage insurance policies, generate proposed insurance claims, generate executable commands, generate notifications, facilitate a purchase (and/or installation) of a replacement device, and/or perform other functionalities. The memory 478 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The controller 420 may further include a communication module 477 configured to communicate data via one or more networks 425. According to some embodiments, the communication module 477 may include one or more transceivers (e.g., WWAN, WLAN, and/or WPAN transceivers) functioning in accordance with IEEE standards, 3GPP standards, or other standards, and/or configured to receive and transmit data via one or more external ports 476. Further, the communication module 477 may include a short-range network component (e.g., an RFID reader) configured for short-range network communications. For instance, the communication module 477 may receive, via the network 425, usage data from a plurality of devices populated within a property.

The controller 420 may further include a user interface 481 configured to present information to a user and/or receive inputs from the user. As shown in FIG. 4, the user interface 481 may include a display screen 482 and I/O components 483 (e.g., ports, capacitive or resistive touch sensitive input panels, keys, buttons, lights, LEDs, speakers, microphones). According to some embodiments, the user may access the controller 420 via the user interface 481 to process insurance policies and/or perform other functions. The controller 420 may be configured to perform insurance-related functions, such as generating proposed insurance claims and facilitating insurance claim processing. In some embodiments, the controller 420 may perform the functionalities as discussed herein as part of a “cloud” network or may otherwise communicate with other hardware or software components within the cloud to send, retrieve, and/or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 422 (e.g., working in connection with the operating system 479) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

### V. EXEMPLARY SERVER

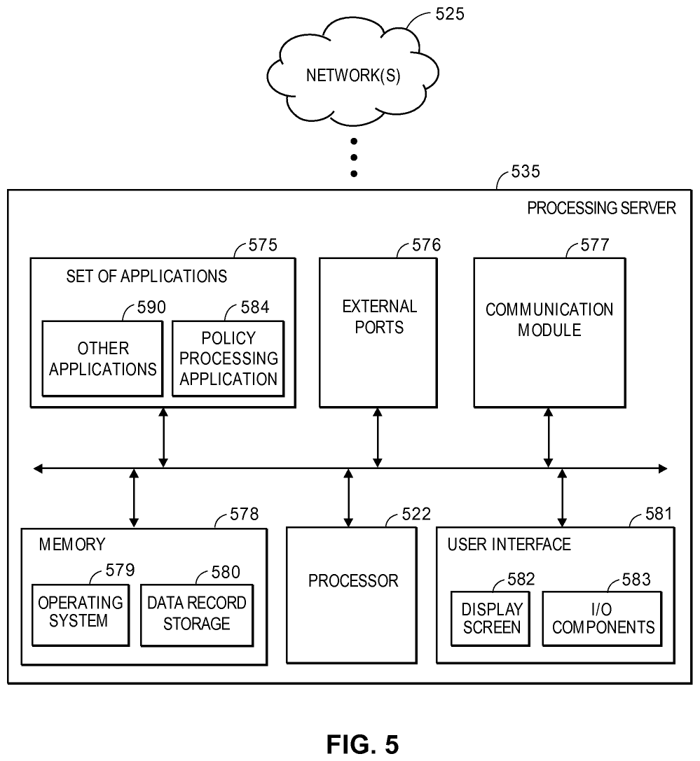

FIG. 5 illustrates a diagram of an exemplary processing server 535 (such as the processing server 135 discussed with respect to FIG. 1) in which the functionalities as discussed herein may be implemented. It should be appreciated that the processing server 535 may be associated with an insurance provider, as discussed herein. In one embodiment, the processing server may be configured with the same functionality as that of the controllers 120, 220 of FIGS. 1 and 2, respectively.

The processing server 535 may include a processor 522, as well as a memory 578. The memory 578 may store an operating system 579 capable of facilitating the functionalities as discussed herein, as well as a set of applications 575 (i.e., machine readable instructions). For instance, one of the set of applications 575 may be a policy processing application 584 configured to manage customer insurance policies. It should be appreciated that other applications 590 are envisioned, such as a device replacement application configured to facilitate the ordering of a replacement device, and/or arranging a third party installation thereof.

The processor 522 may interface with the memory 578 to execute the operating system 579 and the set of applications 575. According to some embodiments, the memory 578 may also include a data record storage 580 that stores various information associated with customer insurance policies. The policy processing application 584 may interface with the data record storage 580 to retrieve relevant information that the policy processing application 584 may use to manage insurance policies, generate notifications, and/or perform other functionalities. Further, the device replacement application may interface with the data record storage 580 to retrieve device information. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The processing server 535 may further include a communication module 577 configured to communicate data via one or more networks 525. According to some embodiments, the communication module 577 may include one or more transceivers (e.g., WWAN, WLAN, and/or WPAN transceivers) functioning in accordance with IEEE standards, 3GPP standards, or other standards, and configured to receive and transmit data via one or more external ports 576. For instance, the communication module 577 may receive, via the network 525, information associated with a replacement device for a device populated within a property.

The processing server 525 may further include a user interface 581 configured to present information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs, speakers, microphones). According to some embodiments, the user may access the processing server 535 via the user interface 581 to process insurance policies and/or perform other functions. In some embodiments, the processing server 535 may perform the functionalities as discussed herein as part of a “cloud” network or may otherwise communicate with other hardware or software components within the cloud to send, retrieve, and/or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 522 (e.g., working in connection with the operating system 579) to facilitate the functions as described herein. In this regard, the program code may be implemented in any desired language, and/or may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

### VI. EXEMPLARY USER INTERFACES FOR FACILITATING DEVICE REPLACEMENT

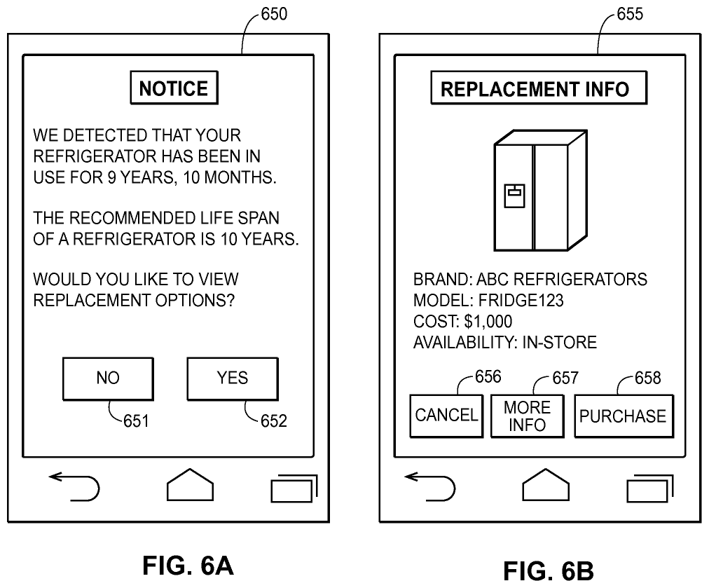

FIGS. 6A and 6B illustrate exemplary interfaces associated with example commands, displays, and actions for smart devices. An electronic device (e.g., a mobile device, such as a smartphone) may be configured to display the interfaces and/or receive selections and inputs via the interfaces. For example, a dedicated application associated with an insurance provider (or with a controller) and that is configured to operate on the electronic device may display the interfaces. It should be appreciated that the interfaces are merely examples and that alternative or additional content is envisioned.

FIG. 6A illustrates an interface 650 including details relating to a notice of device usage. In particular, the interface 650 may include information resulting from a comparison of actual device usage data of a refrigerator to baseline usage data for that refrigerator. The interface 650 may indicate that the refrigerator has been in use for nine (9) years and ten (10) months, where the recommended lifespan of the refrigerator is ten (10) years. In this regard, the user is notified that his/her refrigerator is nearing the end of its recommended lifespan. The interface 650 may further enable a user of the electronic device to select whether to view replacement options via a “NO” selection 651 and a “YES” selection 652.

FIG. 6B illustrates an interface 655 that includes information associated with an exemplary replacement refrigerator. In embodiments, the electronic device may display the interface 655 in response to detecting a selection of the “YES” selection 652 of the interface 650. The interface 655 may include various information associated with the exemplary replacement refrigerator. In particular, as illustrated in FIG. 6B, the information may include an image, a brand, a model, a cost or price, and/or an availability. It should be appreciated that the interface 655 may include alternate or additional information.

The user may view the information of the interface 655 to gauge whether to purchase the replacement refrigerator. As depicted in FIG. 6B, the interface 655 may include a set of selections that enable the user to facilitate various functionalities. In particular, the user may select a “CANCEL” selection 656 to cause the electronic device to exit out of the interface 655 and/or proceed to another interface; a “MORE INFO” selection 657 to cause the electronic device to access various additional information associated with the replacement refrigerator and/or the purchase thereof; and a “PURCHASE” selection 658 to cause the electronic device to facilitate a purchase of the replacement refrigerator with the user. It should be appreciated that additional functionalities are envisioned. For example, the user interface 655 may enable the user to view alternate replacement refrigerator options and/or alternate purchasing channels. The user interface 655 may also allow the user to schedule or otherwise arrange third party installation of the replacement refrigerator, and/or other actions.

### VII. EXEMPLARY METHOD OF MONITORING DEVICE USAGE

In one aspect, a computer-implemented method of monitoring device usage within a property may be provided. The property may be populated with a hardware controller in communication with a plurality of devices. The method may include (1) retrieving, by the hardware controller, device usage data from a device disposed within the property; (2) identifying, from the device usage data, an actual usage amount of the device; (3) accessing a baseline usage amount associated with the device; (4) comparing, by one or more processors, the actual usage amount to the baseline usage amount to determine that the device needs replacement; (5) receiving, from a third-party entity associated with the device, information associated with a replacement device for the device; and/or (6) communicating the information to an electronic device of an individual associated with the property to facilitate alleviating risks associated with insurance-related events, abnormal conditions, and/or devices in need of replacement. The method may include additional, fewer, or alternate actions, including those discussed elsewhere herein.

For instance, to receive the information associated with the replacement device, the computer-implemented method may include (1) receiving for-sale information associated with the replacement device, the for-sale information identifying a for-sale location for the replacement device and a price for the replacement device; and/or (2) receiving a discount offer for the replacement device.

The baseline usage amount may correspond to a recommended usage amount, and to compare the actual usage amount to the baseline usage amount, the computer-implemented method may include (1) calculating a difference between the actual usage amount and the baseline usage amount; and/or (2) determining that the difference is below a threshold amount. The method may further include (1) receiving, from the electronic device, a confirmation by the individual to purchase the replacement device; (2) facilitating a purchase of the replacement device with the third-party entity; and/or (3) scheduling an installation of the replacement device with the third-party entity.

The baseline usage amount may correspond to an operation limit, and to compare the actual usage amount to the baseline usage amount, the computer-implemented method may include determining that the actual usage amount exceeds the operation limit. The baseline usage amount may also correspond to a minimum effective amount, and to compare the actual usage amount to the baseline usage amount, the method may include determining that the actual usage amount fails to meet the minimum effective amount. The computer-implemented method may further include: responsive to comparing the actual usage amount to the baseline usage amount, transmitting, to the third-party entity, a request for the information associated with the replacement device.

### VIII. EXEMPLARY METHOD OF MONITORING DEVICE USAGE

In another aspect, a computer-implemented method of monitoring device usage within a property may be provided. The property may be populated with a hardware controller in communication with a plurality of devices. The method may include (1) retrieving, by a server from the hardware controller, device usage data associated with a device disposed within the property; (2) identifying, from the device usage data, an actual usage amount of the device; (3) accessing a baseline usage amount associated with the device; (4) comparing, by one or more processors of the server, the actual usage amount to the baseline usage amount to determine that the device needs replacement; (5) receiving, from a third-party entity associated with the device, information associated with a replacement device for the device; and/or (6) communicating the information to an electronic device of an individual associated with the property to facilitate device replacement and/or prevention of damage to the property due to device failure. The method may include additional, less, or alternate actions, including those discussed elsewhere herein.

The computer-implemented method may receive the information associated with the replacement device by receiving for-sale information associated with the replacement device, where the for-sale information may identify a for-sale location for the replacement device and a price for the replacement device. The computer-implemented method may alternatively receive the information associated with the replacement device by receiving a discount offer for the replacement device.

In one aspect, the baseline usage amount may correspond to a recommended usage amount, and the computer-implemented method may compare the actual usage amount to the baseline usage amount by calculating a difference between the actual usage amount and the baseline usage amount, and/or determining that the difference is below a threshold amount.

The computer-implemented method may further include receiving, from the electronic device, a confirmation by the individual to purchase the replacement device, and facilitating a purchase (and/or an installation) of the replacement device with the third-party entity.

In one aspect, the baseline usage amount may correspond to an operation limit, and the computer-implemented method may compare the actual usage amount to the baseline usage amount by determining that the actual usage amount exceeds the operation limit. In another aspect, the baseline usage amount may correspond to a minimum effective amount, and/or the computer-implemented method may compare the actual usage amount to the baseline usage amount by determining that the actual usage amount fails to meet the minimum effective amount.

The computer-implemented method may further include, responsive to comparing the actual usage amount to the baseline usage amount, transmitting, to the third-party entity, a request for the information associated with the replacement device.

### IX. EXEMPLARY HARDWARE CONTROLLER

A hardware controller for monitoring device usage within a property may be provided. The hardware controller may be in communication with a plurality of devices. The hardware controller may include a communication module adapted to retrieve device usage data from a device disposed within the property, a memory adapted to store non-transitory computer executable instructions, and/or a processor adapted to interface with the communication module. The processor may be configured to execute the non-transitory computer executable instructions to cause the processor to (1) identify, from the device usage data, an actual usage amount of the device, (2) access a baseline usage amount associated with the device, (3) compare the actual usage amount to the baseline usage amount to determine that the device needs replacement, (4) receive, via the communication module from a third-party entity associated with the device, information associated with a replacement device for the device, and/or (5) transmit, via the communication module, the information to an electronic device of an individual associated with the property. As a result, device replacement may be facilitated and/or damage to the property caused by device failure may be alleviated. The processor may be configured with additional, less, or alternate functionality, including that discussed elsewhere herein.

For instance, the baseline usage amount may correspond to a recommended usage amount, and to compare the actual usage amount to the baseline usage amount, the processor may be configured to calculate a difference between the actual usage amount and the baseline usage amount, and/or determine that the difference is below a threshold amount.

The processor may be further configured to receive, from the electronic device via the communication module, a confirmation by the individual to purchase the replacement device, and/or facilitate a purchase (and/or schedule an installation) of the replacement device with the third-party entity.

In one aspect, the baseline usage amount may correspond to an operation limit, and to compare the actual usage amount to the baseline usage amount, the processor may be configured to determine that the actual usage amount exceeds the operation limit.

### X. ADDITIONAL EMBODIMENTS

The wired or wireless communication or data transmission, and/or data, received and/or analyzed by the smart home controller or remote processor may indicate that a new appliance or other equipment has been installed improperly. In response, and/or based upon the analysis by the smart home controller or remote processor of the wired or wireless communication or data transmission, and/or data received, the smart home controller or remote processor may then generate a corresponding message or wireless communication to the insured indicating such (i.e., improper installation of the new appliance or other equipment). The smart home controller or remote processor may determine that the new appliance has been installed improperly from analysis of (1) images of the new appliance, (2) electrical or water usage by the new appliance, and/or (3) water flow or air flow associated with the new appliance, such as by the smart home controller or remote processor comparing (i) actual images of the new appliance with expected images (such as images of similar appliances) stored in a memory unit or data structure, (ii) actual electrical or water usage of, or by, the new appliance with expected electrical or water usage (such as usage of, or by, similar appliances) stored in a memory unit or data structure; and/or (iii) actual water or air flow associated with the new appliance with expected water or air flow (such flow as associated with similar appliances) stored in a memory unit or data structure. The air flow may be associated with an air conditioning unit, furnace, ventilation system, or clothes dryer exhaust, and the smart home controller or remote processor may determine that the air flow is abnormal and/or lower than expected (indicating actual or potential air flow blockage, leakage, or other abnormalities).

The wired or wireless communication or data transmission, and/or data, received and/or analyzed by the smart home controller or remote processor may indicate that a tiny home has been built or installed improperly. In response, and/or based upon the analysis by the smart home controller or remote processor of the wired or wireless communication or data transmission, and/or data received, the smart home controller or remote processor may then generate a corresponding message or wireless communication to the insured indicating such (i.e., improper installation of the tiny home). The smart home controller or remote processor may determine that the tiny home has been built or installed improperly from analysis of (1) internal and/or exterior images of the tiny home, (2) electrical or water usage by the tiny home, and/or (3) water flow or air flow associated with the tiny home, such as by the smart home controller or remote processor comparing (i) actual images of the tiny home with expected images (associated with other tiny homes) stored in a memory unit or data structure, (ii) actual electrical or water usage of, or by, the tiny home with expected electrical or water usage (of, or by, average tiny homes) stored in a memory unit or data structure; and/or (iii) actual water or air flow of the tiny home, with expected water or air flow (such as that associated with other or average tiny homes) stored in a memory unit or data structure. The air flow may be associated with an air conditioning unit, furnace, ventilation system, or clothes dryer exhaust, and the smart home controller or remote processor may determine that the air flow is abnormal and/or lower than expected.

### XI. EXEMPLARY ENERGY CONSUMPTION & UTILITY USAGE

The methods related to smart home control and/or automation detailed elsewhere herein may also include actions directed to energy consumption and/or utility usage. For instance, the wired or wireless communication or data transmission, and/or data, received and/or analyzed by the smart home controller or remote processor may include electrical load data transmitted by a smart outlet or smart circuit breaker. The smart home controller or remote processor may be configured to determine that an electric load for a smart appliance is excessive or over a pre-determined threshold from analysis of the electrical load data received by the smart home controller or remote processor, and then automatically disconnect or turn off the smart appliance and/or send the insured a corresponding warning message.

The wired or wireless communication or data transmission, and/or data, received and/or analyzed by the smart home controller or remote processor may include electrical load data associated with electricity consumption by a piece of equipment. The smart home controller or remote processor may be configured to determine that the piece of equipment is nearing an end of its useful life or should be replaced from analysis of the electrical load data received by the smart home controller or remote processor, and then automatically determined a replacement piece of equipment, and recommend the replacement piece of equipment to the insured, such as via wireless communication.

The wired or wireless communication or data transmission, and/or data, received and/or analyzed by the smart home controller or remote processor may include audio data associated with a running or operating piece of equipment (e.g., sound of a pump, motor, dish washer, clothes washer or dryer, air conditioning unit, refrigerator, furnace, sump pump or sump pump motor, etc.). The smart home controller or remote processor may be configured to determine that the piece of equipment is nearing an end of its useful life or should be replaced from analysis of the audio data received by the smart home controller or remote processor, and then automatically determine and/or recommend a replacement piece of equipment to the insured, such as via wireless communication.

The wired or wireless communication or data transmission, and/or data, received and/or analyzed by the smart home controller or remote processor may include electrical load data associated with electricity consumption within an insured home. The smart home controller or remote processor may be configured to re-route electric power from an electric vehicle to a generator, sump pump, refrigerator, or air conditioner during a power outage based upon analysis of the electricity consumption or electric load data by the smart home controller or remote processor.

The wired or wireless communication or data transmission, and/or data, received and/or analyzed by the smart home controller or remote processor may include electrical load data associated with electricity consumption within an insured home. The smart home controller or remote processor may be configured to notify the insured of large increases in usage or usage spikes that are indicative of equipment failure or impending failure, such as a sump pump running continuously and failing to properly turn off, based upon analysis of the electricity consumption or electric load data by the smart home controller or remote processor.

The wired or wireless communication or data transmission, and/or data, received and/or analyzed by the smart home controller or remote processor may include electrical usage information related to electricity consumption within an insured home. The smart home controller or remote processor may be configured to make a recommendation about energy usage to the insured that offers electricity cost savings to the insured based upon analysis of the electricity consumption or electrical usage information by the smart home controller or remote processor.

The smart home controller or remote processor may receive a notification of severe weather in the vicinity of the insured home, such as via wired or wireless communication, and then may direct a smart electrical system of the insured home to shut off or de-energize specific, or even all, loads (e.g., appliances, electrical devices, computers, televisions, etc.) to prevent damage to the loads (e.g., de-energize expensive televisions, electronic devices, or computers) during a thunderstorm or other event that may cause a power surge.

### XII. ADDITIONAL CONSIDERATIONS

As used herein, the term “smart” may refer to devices, sensors, or appliances located within or proximate to a property, and with the ability to communicate information about the status of the device, sensor, or appliance and/or receive instructions that control the operation of the device, sensor, or appliance. In one instance, a smart thermostat may be able to remotely communicate the current temperature of the home and receive instructions to adjust the temperature to a new level. In another instance, a smart water tank may be able to remotely communicate the water level contained therein and receive instructions to restrict the flow of water leaving the tank. In contrast, “dumb” devices, sensors, or appliances located within or proximate to a property require manual control (as compared to automatic or semi-automatic or processor control associated with smart devices). Referring again to the thermostat embodiment, to adjust the temperature on a “dumb” thermostat, a person would have to manually interact with the thermostat. As such, a person is unable to use a communication network to remotely adjust a “dumb” device, sensor, or appliance.

A “smart device” as used herein may refer to any of a smart device, sensor, appliance, and/or other smart equipment that may be located (or disposed) within or proximate to a property. In some embodiments in which an appliance and a sensor external to the particular appliance are associated with each other, “smart device” may refer to both the external sensors and the appliance collectively. Some exemplary devices that may be “smart devices” are, without limitation, valves, piping, clothes washers/dryers, dish washers, refrigerators, sprinkler systems, toilets, showers, sinks, soil monitors, doors, locks, windows, shutters, ovens, grills, fire places, furnaces, lighting, sump pumps, security cameras, and alarm systems. Similarly, an individual associated with the property shall be referred to as the “homeowner,” “property owner,” or “policyholder,” but it is also envisioned that the individual is a family member of the homeowner, a person renting/subletting the property, a person living or working on the property, a neighbor of the property, or any other individual that may have an interest in preventing or mitigating damage to the property.

Further, any reference to “home” or “property” is meant to be exemplary and not limiting. The systems and methods described herein may be applied to any property, such as offices, farms, lots, parks, and/or other types of properties or buildings. Accordingly, “homeowner” may be used interchangeably with “property owner.”

With the foregoing, an insurance customer may opt-in to a rewards, insurance discount, or other type of program. After the insurance customer provides their affirmative consent, an insurance provider remote server may collect data from the customer's mobile device, smart home controller, or other smart devices—such as with the customer's permission. The data collected may be related to insured assets before (and/or after) an insurance-related event, including those events discussed elsewhere herein. In return, risk averse insureds, home owners, or home or apartment occupants may receive discounts or insurance cost savings related to home, renters, personal articles, auto, and other types of insurance from the insurance provider.

In one aspect, smart or interconnected home data, and/or other data, including the types of data discussed elsewhere herein, may be collected or received by an insurance provider remote server, such as via direct or indirect wireless communication or data transmission from a smart home controller, mobile device, or other customer computing device, after a customer affirmatively consents or otherwise opts-in to an insurance discount, reward, or other program. The insurance provider may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, or vehicles, and/or (ii) home or apartment occupants.

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For instance, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For instance, where the hardware modules comprise a general-purpose processor configured using software, the general-purpose processor may be configured as respective different hardware modules at different times. Software may accordingly configure a processor, for instance, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for instance, through the storage and retrieval of information in memory structures to which the multiple hardware modules have access. For instance, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For instance, at least some of the operations of a method may be performed by one or more processors or processor-implemented hardware modules. The performance of certain of the operations may be distributed among the one or more processors, not only residing within a single machine, but deployed across a number of machines. In some exemplary embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

Although the embodiments discussed herein relate to home or personal property insurance policies, it should be appreciated that an insurance provider may offer or provide one or more different types of insurance policies. Other types of insurance policies may include, for instance, condominium owner insurance, renter's insurance, life insurance (e.g., whole-life, universal, variable, term), health insurance, disability insurance, long-term care insurance, annuities, business insurance (e.g., property, liability, commercial auto, workers compensation, professional and specialty liability, inland marine and mobile property, surety and fidelity bonds), automobile insurance, boat insurance, insurance for catastrophic events such as flood, fire, volcano damage and the like, motorcycle insurance, farm and ranch insurance, personal liability insurance, personal umbrella insurance, community organization insurance (e.g., for associations, religious organizations, cooperatives), personal articles, and/or other types of insurance products. In embodiments as described herein, the insurance providers process claims related to insurance policies that cover one or more properties (e.g., homes, automobiles, personal property), although processing other insurance policies is also envisioned.

The terms “insured,” “insured party,” “policyholder,” “customer,” “claimant,” and “potential claimant” are used interchangeably herein to refer to a person, party, or entity (e.g., a business or other organizational entity) that is covered by the insurance policy, e.g., whose insured article or entity (e.g., property, life, health, auto, home, business) is covered by the policy. A “guarantor,” as used herein, generally refers to a person, party or entity that is responsible for payment of the insurance premiums. The guarantor may or may not be the same party as the insured, such as in situations when a guarantor has power of attorney for the insured. An “annuitant,” as referred to herein, generally refers to a person, party or entity that is entitled to receive benefits from an annuity insurance product offered by the insuring party. The annuitant may or may not be the same party as the guarantor.

As used herein, the terms “comprises,” “comprising,” “includes,” “including,” “has,” “having” or any other variation thereof, are intended to cover a non-exclusive inclusion. For instance, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For instance, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as examples and does not describe every possible embodiment, as describing every possible embodiment would be impractical, if not impossible. One could implement numerous alternate embodiments, using either current technology or technology developed after the filing date of this application.

1. A computer-implemented method of monitoring device usage within a property, the property populated with a hardware controller in communication with a plurality of devices, the hardware controller comprising a first special-purpose processor, the method comprising:
transmitting, by the hardware controller via a network connection, a request to an electronic device within the property for electronic device usage data by the electronic device over a specific time period;
in response to transmitting the request, receiving, by the hardware controller from the electronic device via the network connection, the electronic device usage data for the specific time period;
identifying, by the first special-purpose processor and based at least in part upon the electronic device usage data for the specific time period, an actual electronic usage amount of the device over a lifetime of the electronic device corresponding to a total operating time of the device different from the lifetime of the device;
accessing, by the hardware controller and from a data source associated with a third-party entity comprising at least one of a manufacturer or supplier of the device, a recommended lifetime electronic usage amount associated with the device;
determining, by the first special-purpose processor, to recommend replacement of the device by:
calculating, by the first special-purpose processor, a percentage representing a difference between the actual electronic usage amount and the recommended lifetime electronic usage amount;
determining, by the first special-purpose processor, that the percentage is within a predetermined threshold percentage of the recommended lifetime electronic usage amount, the predetermined threshold percentage being associated with an indication of when the actual electronic usage amount is nearing the recommended lifetime electronic usage amount; and
determining, by the first special-purpose processor, to recommend replacement of the electronic device based upon the percentage being within the predetermined threshold percentage of the recommended lifetime electronic usage amount.

2. The computer-implemented method of claim 25, wherein receiving the information associated with the replacement electronic device comprises:
receiving for-sale information associated with the replacement electronic device, the for-sale information identifying a for-sale location for the replacement electronic device and the price for the replacement electronic device.

3. The computer-implemented method of claim 25, wherein receiving the information associated with the replacement electronic device comprises:
receiving a discount offer for the replacement electronic device.

4. (canceled)

5. The computer-implemented method of claim 25, further comprising:
receiving, by the hardware controller from the personal electronic device, a confirmation by the individual to purchase the replacement electronic device; and
facilitating, by the hardware controller, a purchase of the replacement electronic device with the third-party entity.

6. (canceled)

7. (canceled)

8. The computer-implemented method of claim 25, further comprising:
responsive to comparing the actual electronic usage amount to the recommended lifetime electronic usage amount, transmitting, by the hardware controller to the third-party entity, a request for the information associated with the replacement electronic device.

9. A computer-implemented method of monitoring device usage within a property, the property populated with a hardware controller in communication with a plurality of devices, the method comprising:
transmitting, by a server via a network connection, a first request to the hardware controller to retrieve electronic device usage data over a specific time period associated with an electronic device disposed within the property;
transmitting, by the hardware controller via the network connection, a second request to the electronic device within the property for the electronic device usage data over the specific time period;
in response to transmitting the second request, receiving, by the hardware controller from the device via the network connection, the electronic device usage data over the specific time period;
in response to transmitting the first request, receiving, by the server via the network connection, the electronic device usage data by the electronic device over the specific time period;
identifying, by a first special-purpose processor of the server and based at least in part upon the electronic device usage data over the specific time period, an actual electronic usage amount of the device over a lifetime of the electronic device corresponding to a total operating time of the device different from the lifetime of the device;
accessing, by the server and from a data source associated with a third-party entity comprising at least one of a manufacturer or supplier of the device, a recommended lifetime electronic usage amount associated with the electronic device;
determining, by the first special-purpose processor, to recommend replacement of the device by:
calculating, by the first special-purpose processor, a percentage representing a difference between the actual electronic usage amount and the recommended lifetime electronic usage amount;
determining, by the first special-purpose processor, that the percentage is within a predetermined threshold percentage of the recommended lifetime electronic usage amount, the predetermined threshold percentage being associated with an indication of when the actual electronic usage amount is nearing the recommended lifetime electronic usage amount; and
determining, by the first special-purpose processor, to recommend replacement of the electronic device based upon the percentage being within the predetermined threshold percentage of the recommended lifetime electronic usage amount.

10. The computer-implemented method of claim 9, further comprising:
receiving for-sale information associated with a replacement electronic device, the for-sale information identifying a for-sale location for the replacement electronic device and a price for the replacement electronic device.

11. The computer-implemented method of claim 9, further comprising receiving a discount offer for a replacement electronic device.

12. (canceled)

13. The computer-implemented method of claim 9, further comprising:
receiving, by the server from a personal electronic device associated with an individual associated with the property, a confirmation by the individual to purchase a replacement electronic device; and
facilitating, by the server, a purchase of the replacement electronic device with the third-party entity.

14. (canceled)

15. (canceled)

16. The computer-implemented method of claim 9, further comprising:
responsive to comparing the actual electronic usage amount to the recommended lifetime electronic usage amount, transmitting, by the server to the third-party entity, a request for information associated with a replacement electronic device.

17. A hardware controller for monitoring electronic device usage within a property, the hardware controller in communication with a plurality of devices, comprising:
a communication module adapted to retrieve electronic device usage data from an electronic device disposed within the property;
a memory adapted to store non-transitory computer executable instructions; and
a special-purpose processor adapted to interface with the communication module, wherein the special-purpose processor is configured to execute the non-transitory computer executable instructions to cause the special-purpose processor to:
transmit, via the communication module, a request to the electronic device for electronic device usage data by the electronic device over a specific time period;
receive, via the communication module, the electronic device usage data for the specific time period;
in response to a transmission of the request, receive, from the electronic device, the electronic device usage data for the specific time period;
identify, based at least in part upon the electronic device usage data for the specific time period, an actual electronic usage amount of the device over a lifetime of the electronic device corresponding to a total operating time of the device different from the lifetime of the device;
access, from a data source associated with a third-party entity comprising at least one of a manufacturer or supplier of the device, a recommended lifetime electronic usage amount associated with the device;
determine to recommend replacement of the device by:
calculating a percentage representing a difference between the actual electronic usage amount and the recommended lifetime electronic usage amount;
determining that the percentage is within a predetermined threshold percentage of the lifetime electronic recommended usage amount, the predetermined threshold percentage being associated with an indication of when the actual electronic usage amount is nearing the recommended lifetime electronic usage amount; and
determining to recommend replacement of the electronic device based upon the percentage being within the predetermined threshold percentage of the lifetime electronic recommended usage amount.

18. (canceled)

19. The hardware controller of claim 17, wherein the special-purpose processor is further configured to:
receive, from a personal electronic device associated with an individual associated with the property via the communication module, a confirmation by the individual to purchase a replacement electronic device, and
facilitate a purchase of the replacement electronic device with the third-party entity.

20. (canceled)

21. The computer-implemented method of claim 1, further comprising:
identifying, by the hardware controller, a policy associated with the electronic device;
generating, by the hardware controller, a proposed claim based at least in part upon the policy; and
transmitting, by the hardware controller to a personal electronic device associated with an individual associated with the property, the proposed claim, wherein the proposed claim includes one or more pre-populated fields.

22. The computer-implemented method of claim 1, further comprising automatically turning off the electronic device in response to the percentage being within the predetermined threshold percentage of the recommended lifetime electronic usage amount.

23. The computer-implemented method of claim 1, further comprising transmitting the request to the electronic device via a second controller, wherein the second controller is in communication with the electronic device.

24. The computer-implemented method of claim 1, further comprising receiving the electronic device usage data from the electronic device via a second controller, wherein the second controller is in communication with the electronic device.

25. The computer-implemented method of claim 1, further comprising:
receiving, by the hardware controller from the third-party entity associated with the electronic device, information associated with a replacement electronic device for the electronic device, wherein the information identifies the replacement electronic device and comprises at least one image of the replacement electronic device and a price for the replacement electronic device; and
communicating, by the hardware controller, the information to a personal electronic device of an individual associated with the property, wherein the personal electronic device comprises a second special-purpose processor that is configured to concurrently (i) display, in a user interface, the at least one image and the price, and (ii) enable the individual to select to purchase the replacement electronic device via a purchase selection displayed in the user interface.
